(19) United States
(12) Patent Application Publication
(10) Pub. No.: US 2006/0056677 A1
(43) Pub. Date: Mar. 16, 2006

(54) Mobile cleaner

(75) Inventor: Takao Tani, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-Shi (JP)

(21) Appl. No.: 11/210,453

(22) Filed: Aug. 24, 2005

(30) Foreign Application Priority Data
Aug. 24, 2004 (JP) P. 2004-244374

(51) Int. Cl. G06K 9/00

(52) U.S. Cl. 382/153

(57) ABSTRACT

A mobile cleaner includes: a running unit for automatically moving along a floor face; a cleaning unit for cleaning the floor face; an image taking unit for taking an image of a surrounding; and a switching unit for switching to a state of exposing an opening portion of the image taking unit to be able to take the image of the surrounding and a state of concealing the opening portion of the image taking unit to be unable to take the image of the surrounding.

### BACKGROUND OF THE INVENTION

1. Field of the Invention

The present invention relates to a mobile cleaner for cleaning a floor by automatically running along a floor face.

2. Description of the Related Art

Heretofore, there has been developed a mobile cleaner having a cleaning blush or a suction port for collecting dust as well as a drive wheel at a bottom face portion of a main body of an apparatus for cleaning a floor while automatically running along a floor face by the drive wheel. According to such a mobile cleaner, the mobile cleaner is frequently operated while being absent or in a room where a person is not present and therefore, there has also been developed a mobile cleaner having a security function for monitoring whether there is invasion of a suspicious person in operating the mobile cleaner.

The security function is realized by providing a movie camera for taking an image of a surrounding, and a human body sensor for sensing motion of a person by detecting an infrared ray at a mobile cleaner and when motion of a person is detected by the human body sensor, taking an image of a surrounding thereof by the movie camera. Further, there also is a security function for automatically transmitting the taken image to a computer network by utilizing wireless communication.

Further, in background arts, as a system or an apparatus of automatically taking an image of a human body by a movie camera, there are, for example, a camera control apparatus disclosed in JP-A-10-164418, a television telephone apparatus disclosed in JP-A-06-121305, a fire emergency escape guiding system disclosed in JP-A-05-002693, and various inventions have been carried out in such a system and an apparatus.

According to the above-described mobile cleaner having a security function, when the security function is not operated, presence of the movie camera makes a person nervous. For example, in the case in which when the movie camera of a mobile cleaner is directed to a person when the mobile cleaner is operated while the person stays in a room or when the person is at ease in a room, the person feels uneasy whether the mobile cleaner is operated erroneously or whether the image of the person is taken by erroneous operation.

### SUMMARY OF THE INVENTION

It is an object of the invention to provide a mobile cleaner by which a user does not feel uneasy by whether an image of the user is erroneously taken when a movie camera is not used in a mobile cleaner provided with the movie camera with a purpose of a security function or the like.

In order to achieve the above object, the invention is constituted by a mobile cleaner including: a running unit for automatically moving along a floor face; a cleaning unit for cleaning the floor face; an image taking unit capable of taking an image of a surrounding; and a switching unit capable of switching to a state of exposing an opening portion of the image taking unit to be able to take the image of the surrounding and a state of concealing the opening portion of the image taking unit to be unable to take the image of the surrounding.

According to the constitution, when the image taking unit is not used, by concealing the opening portion by the switching unit, the image taking unit cannot physically take the image. Therefore, the user does not feel uneasy by whether the image is taken erroneously.

Specifically, there may be constructed a constitution in which the switching unit is constituted to be able to switch the image taking unit to a state of being contained at an upper face portion of an apparatus and a state of projecting the opening portion of the image taking unit from the upper face of the apparatus by being pivoted centering on a support shaft.

According to the constitution, a state of the image taking unit can optically be recognized from an upper side even when the cleaner is directed in any direction, in a state of concealing the image taking unit, an outlook similar to that of an apparatus which is not mounted with the image taking unit is constituted and therefore, even when a guest or the like takes a look at the apparatus, the guest can be prevented from feeling uneasy.

Further, specifically, there may be constructed a constitution in which the opening portion of the image taking unit is arranged on a front face side of an apparatus main body, and the switching unit is a shutter capable of exposing or concealing the opening portion by being slid.

According to the constitution, a structure of attaching the image taking unit and a constitution of the switching unit can be simplified and a reduction in fabrication cost can be achieved.

Preferably, the mobile cleaner may further includes a detecting unit for detecting the states switched by the switching unit, an informing unit for informing that the image cannot be taken by the image taking unit (for example, detection by voice message, buzzer, music or the like) and a controlling unit for operating the informing unit when the switched state of being unable to take the image is detected by the detecting unit in starting a processing of taking the image of a surrounding by the image taking unit.

According to the constitution, when the security function is intended to be made ON while bringing the switching unit into the state of being unable to take the image, a person is urged to switch the switching unit to the state of being able to take the image by informing and therefore, oversight of switching the switching unit can be prevented.

Further preferably, there may be constructed a constitution in which the detecting unit is constituted to detect the states of the switching unit based on a signal of the image taken by the image taking unit.

Although the states of the switching unit can also be detected by a proximity switch or the like, inherently, the states of the switching unit (that is, whether the front side is closed by brightness of the taken image signal) by the movie function of the image taking unit and therefore, by utilizing the movie function, a number of parts can be reduced and a reduction in cost can be achieved.

As has been explained above, according to the invention, in the mobile cleaner having the image taking unit, there is achieved an effect of capable of avoiding that the image taking unit is erroneously operated or the image taking unit takes the image of the surrounding by erroneous operation when the image taking unit is not intend to operate, further, a user feels uneasy thereby.

### BRIEF DESCRIPTION OF THE DRAWINGS

These and other objects and advantages of this invention will become more fully apparent from the following detailed description taken with the accompanying drawings in which:

FIG. 1 is a perspective view showing a mobile cleaner according to a first embodiment of the invention;

FIG. 2 is a side view showing a structure of a movable portion of a movie camera;

FIG. 3 is a front view showing a mobile cleaner according to a second embodiment of the invention; and

FIG. 4 is a plane view of the mobile cleaner of FIG. 2.

### DETAILED DESCRIPTION OF THE PREFERRED EMBODIMENTS

Embodiments of the invention will be explained in reference to the drawings as follows.

### First Embodiment

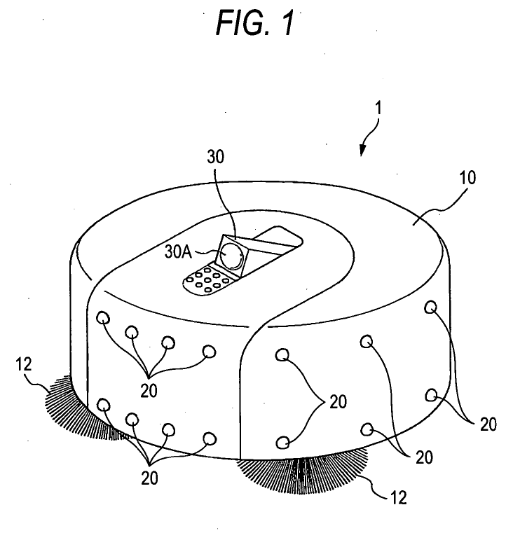

FIG. 1 is a perspective view showing a mobile cleaner according to a first embodiment of the invention.

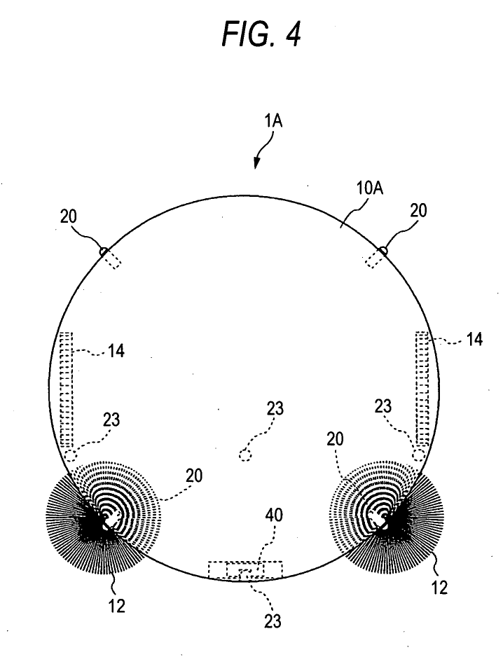

A mobile cleaner 1 according to the embodiment is an apparatus having a cleaner main body portion 10 constituted by a shape of a cylinder having a low height, a pair of cleaning blushes 12, 12 provided at left and right front sides of a bottom face of the main body portion 10, and a pair of drive wheels, not illustrated, (refer to drive wheel 14 of FIG. 3, FIG. 4) arranged in a state of exposing portions thereof from the bottom face on the two left and right sides of the main body portion 10 for automatically cleaning a floor face by the cleaning blushes 12, 12 or the like while automatically running on the floor face by being driven by the drive wheels.

Further, the mobile cleaner 1 is provided with a single piece or a plurality of pieces of driven rollers for supporting the main body portion 10 in a state of being movable in a front and rear direction and in a left and right direction, a suction port for sucking dust, and a sensor or the like for detecting a stepped difference of the floor face on the front side and the two left and right sides of the main body portion 10.

Further, the mobile cleaner 1 is provided with a security function for monitoring whether a suspicious person or the like is present in cleaning operation, and is provided with a plurality of human body sensors 20 . . . for detecting motion of an object having temperatures of the human body or the like by detecting an ultraviolet ray thereof, and a movie camera 30 for taking an image of a front face side of the cleaner 1. The movie camera 30 is provided at an upper face of the main body portion 10, further, at a periphery of an opening portion of the movie camera 30, there is provided LED illumination for illuminating the front side.

Further, inside of the mobile cleaner 1 is provided with a wireless communication unit for transmitting image data taken by the movie camera 30 to an outside computer or computer network by wireless communication.

According to the mobile cleaner 1 of the embodiment, by a popup mechanism as a switching unit, an opening portion 30A of the movie camera 30 can be concealed at inside of the apparatus or exposed to outside of the apparatus. That is, by pushing down a rear end portion 30a of the movie camera 30 by a user, the movie camera 30 is pivoted centering on a support shaft 32, and the opening portion 30A is exposed to outside of the apparatus to thereby enable to take an image of outside. Further, at this occasion, a locking portion of the movie camera 30, not illustrated, is locked by a main body cabinet to thereby hold a state of the movie camera 30. On the other hand, by pushing downward a front portion 30b of the movie camera 30, the locking portion is disengaged from being latched and the movie camera 30 is pivoted centering on the support shaft 32, and the opening portion 30A is concealed at inside of the apparatus. At this occasion, the movie camera 30 is contained in the main body portion 10 and an upper face thereof and an upper face of the cabinet of the main body portion 10 are made to be flush with each other.

Further, as a mechanism of pivoting or locking the movie camera 30, by providing a locking structure in which, for example, by operating a spring force upward from a lower side of the front portion of the movie camera 30 and pushing the front portion 30b to the lower side by a first time, the movie camera 30 is locked by the cabinet and the front portion 30b is disengaged from being locked thereby by pushing the front portion 30b at a second time, the movie camera 30 can be facilitated to be brought in and out.

According to the above-described constitution, by setting the security function ON by a user, it is monitored whether motion of a person is present at a surrounding of the mobile cleaner 1 by an output detected by the human body sensors 20 . . . , as a result, when motion of a person is detected, an image thereof is taken by the movie camera 30 by directing the movie camera 30 to a destination of the detection. Further, the image data is automatically transmitted to an outside computer by way of wireless communication.

Further, when the security function is set ON, CPU in the apparatus analyzes an image signal from the movie camera 30 and determines whether the image is an image in a state of concealing the movie camera 30 in the apparatus. As a result, when CPU determine that the image is the image in the state of concealing the movie camera 30 in the apparatus, there is carried out a processing of outputting informing sound or voice message and informing a user that the movie camera 30 is contained in the apparatus.

As described above, according to the mobile cleaner 1 of the embodiment, by the above-described security function, for example, when there is invasion of a suspicious person, an image of the suspicious person can be taken by the movie camera 30 of the mobile cleaner 1 and the image can be transmitted to outside. Further, thereby, security can be achieved.

Further, there is constructed a structure of concealing the movie camera 30 when the security function is not used and therefore, by concealing the opening portion of the movie camera 30, the image of the surrounding cannot physically be taken by the movie camera 30, and the user can be avoided from feeling uneasy whether the image of the user is taken erroneously.

Further, the movie camera 30 can be switched to a state of being able to take an image by being projected from the upper face portion of the main body portion 10 and a state of being unable to take an image by being contained in the upper face portion of the main body portion 10 and therefore, a state of the movie camera 30 can be confirmed from an upper side even when the cleaner is directed in any direction, and since the state of concealing the movie camera 30 constitutes an outlook similar to that of an apparatus which is not mounted with the movie camera 30, for example, even when a guest takes a look at the cleaner, the gust can be prevented from feeling uneasy.

Further, when the security function is set to ON, the state of switching the movie camera 30 is confirmed, and when the movie camera 30 is brought into a switched state in which the image cannot be taken, a processing of informing the state to the user is carried out and therefore, oversight of exposing the movie camera 30 in the security operation can be prevented.

Further, at this occasion, the state of the movie camera 30 is confirmed by the processing of analyzing image data taken by the movie camera 30 and therefore, in comparison with a case of using a mechanical part of a proximity switch or the like, a number of parts can be reduced and a reduction in cost can be achieved.

### Second Embodiment

FIG. 3 and FIG. 4 show constitution views of a mobile cleaner 1A according to a second embodiment. FIG. 3 is a front view of the mobile cleaner 1A and FIG. 4 is a plane view thereof.

The mobile cleaner 1A of the second embodiment differs from the first embodiment only in an arrangement of the movie camera and a constitution of concealing an opening portion thereof and other constitution thereof is substantially similar to that of the first embodiment.

In FIG. 3 and FIG. 4, notation 10A designates a main body portion of the mobile cleaner 1A, numeral 12 designates the cleaning blush, numerals 14 designate the drive wheels, numerals 20 . . . designate the human body sensors, and numerals 23 . . . designate stepped difference detecting sensors. Further, a bottom face portion of the main body portion 10A is provided with a single piece or a plurality of pieces of driven rollers for supporting the main body portion 10A in a state of being movable in a front and rear direction and in a left and right direction, and a sucking port for sucking dust although illustration thereof is omitted.

According to the mobile cleaner 1A of the embodiment, a movie camera 40 used for a security function is arranged on a front face side of the apparatus and LED illuminations 42 . . . are provided at a surrounding of an opening portion thereof. Further, the front face portion of the opening portion of the movie camera 40 is provided with a shutter 45 as a switching unit capable of covering the opening portion of the camera 40 and the LED illuminations 42 . . . .

The shutter 45 is constituted by a flat plate portion constituted by a fog lens, rail grooves provided at both left and right ends of the flat plate portion and a locking piece provided at an upper end of the flat plate portion although a detailed illustration thereof will be omitted. Further, the rail grooves of the shutter 45 are fitted to slide rails provided on both sides of the opening portion of the camera 40 of the apparatus cabinet and the shutter 45 is made to be movable slidably in an up and down direction. Further, when the shutter 45 is moved to slide upward to cover the opening portion of the movie camera 40, the locking piece of the shutter 45 is caught by a locking portion provided at the apparatus cabinet to hold a position thereof.

According to the mobile cleaner 1A of the embodiment, by the security function, when, for example, there is invasion of a suspicious person, an image of the suspicious person is taken by the movie camera 40 of the mobile cleaner 1A and the image can be transmitted to outside. Further, thereby, security can be achieved.

Further, when the security function is not used, by concealing the opening portion of the movie camera 40 by the shutter 45, the image at the surrounding cannot be physically taken and therefore, the user can be avoided from feeling uneasy by whether the image is taken erroneously.

Further, a constitution of switching to conceal or expose the opening portion is realized by the shutter 45 slidingly movable in the up and down direction and therefore, a reduction in fabrication cost can be achieved by a simple constitution. Further, also the structure of attaching the movie camera 40 becomes simple and a reduction in fabrication cost can be achieved.

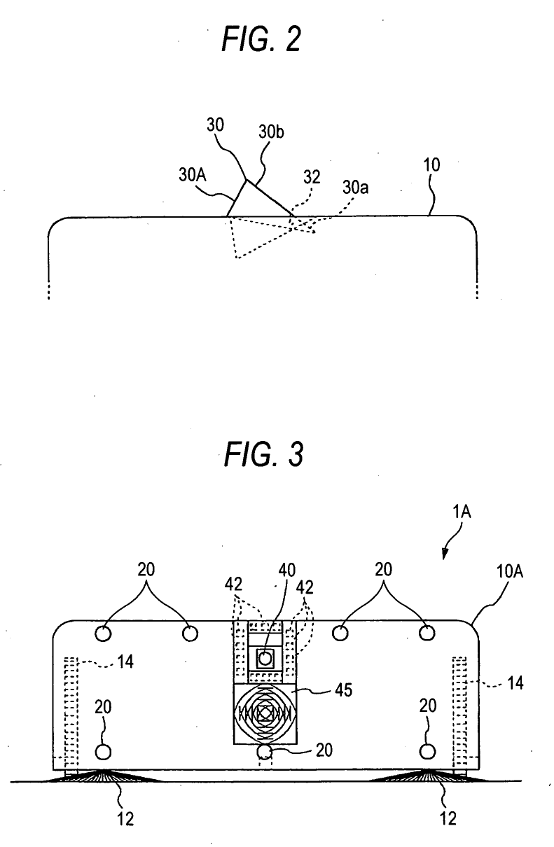

Further, the invention is not limited to the above-described embodiments but can variously be changed. For example, although as means for concealing or exposing the opening portion of the movie camera, the popup mechanism of FIG. 1 and FIG. 2 and the shutter constitution of FIG. 3 are exemplified, otherwise, any constitution may be applied so far as the constitution can switch the movie camera to the similar states and the states can optically be recognized by the user.

What is claimed is:

1. A mobile cleaner comprising:
a running unit for moving along a floor face;
a cleaning unit for cleaning the floor face;
a controlling unit for controlling the running unit;
an image taking unit for taking an image of a surrounding;
a switching unit for making the image taking unit switches to a state of exposing an opening portion of the image taking unit from an upper face of an apparatus and a state of containing the image taking unit at the upper face portion of the apparatus by being pivoted centering on a support shaft;
a detecting unit for detecting the states switched by the switching unit based on a signal of the image taken by the image taking unit; and
an informing unit for informing that the image of the surrounding cannot be taken by the image taking unit,
wherein the controlling unit makes the detecting unit detect the states switched by the switching unit when a monitoring processing for taking the image of the surrounding by the image taking unit is started and operating the informing unit when the image taking unit is brought into a state of being unable to take the image of the surrounding.

2. A mobile cleaner comprising:
a running unit for automatically moving along a floor face;
a cleaning unit for cleaning the floor face;
an image taking unit for taking an image of a surrounding; and
a switching unit for switching to a state of exposing an opening portion of the image taking unit to be able to take the image of the surrounding and a state of concealing the opening portion of the image taking unit to be unable to take the image of the surrounding.

3. The mobile cleaner according to claim 2,
wherein the switching unit switches the image taking unit to a state of being contained at an upper face portion of an apparatus and a state of projecting the opening portion of the image taking unit from the upper face of the apparatus by being pivoted centering on a support shaft.

4. The mobile cleaner according to claim 2,
wherein the opening portion of the image taking unit is arranged on a front face side of an apparatus main body; and
wherein the switching unit is a shutter capable of exposing or concealing the opening portion by being slid.

5. The mobile cleaner according to claim 2, further comprising:
a detecting unit for detecting the states switched by the switching unit;
an informing unit for informing that the image cannot be taken by the image taking unit; and
a controlling unit for operating the informing unit when the switched state of being unable to take the image is detected by the detecting unit in starting a processing of taking the image of the surrounding by the image taking unit.

6. The mobile cleaner according to claim 5,
wherein the detecting unit detects the states of the switching unit based on a signal of the image taken by the image taking unit.
